(19) United States
(12) Patent Application Publication
(10) Pub. No.: US 2024/0194990 A1
(43) Pub. Date: Jun. 13, 2024

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Takashi TAKIMOTO, Kosai-shi (JP); Shigeru MATSUMOTO, Toyohashi-shi (JP); Yasuaki NAGANO, Kosai-shi (JP)

(21) Appl. No.: 18/492,782

(22) Filed: Oct. 24, 2023

(30) Foreign Application Priority Data
Dec. 7, 2022 (JP) 2022-195278

(51) Int. Cl. H01M 50/176; H01M 50/184; H01M 50/186; H01M 50/557

(52) U.S. Cl. CPC H01M 50/176; H01M 50/184; H01M 50/186; H01M 50/557; H01M 50/15

(57) ABSTRACT

A power storage device includes a case having a metal lid with an insertion hole, a terminal member inserted through the insertion hole, and a resin member insulating between the case and the terminal member. The terminal member is made of a flat plate-shaped metal member bent to form an inner terminal part and an outer terminal part including a connection flat surface. The outer terminal part includes an outer main portion extending from an area joined to the inner terminal part to one side in a thickness direction of the inner terminal part, forming over half of the connection flat surface, and an outer protruding portion protruding on the other side in the thickness direction, forming the rest of the connection flat surface. The terminal member has a T-shaped cross-section at a portion including the joined area of the inner and outer terminal parts.

### CROSS-REFERENCE TO RELATED APPLICATIONS

This application is based upon and claims the benefit of priority to Japanese Patent Application No. 2022-195278 filed on Dec. 7, 2022, the entire contents of which are incorporated herein by reference.

### BACKGROUND

### Technical Field

The present disclosure relates to a power storage device.

### Related Art

An example of a power storage device is known as a rectangular battery in which a positive terminal member and a negative terminal member are each fixed to a rectangular parallelepiped box-shaped case via resin members. In such a power storage device, for example, the case includes a bottomed rectangular tube-shaped case body having an opening defined by a rectangular ring-shaped opening end, and a rectangular plate-shaped lid welded to the case body over the entire perimeter of the case body to close the opening. Further, the positive and negative terminal members are individually inserted through a pair of insertion holes provided in the lid to extend from inside to outside of the case. The resin members are each joined to both the lid and the corresponding positive or negative terminal member to ensure airtightness while insulating between the lid and the terminal members. One example of the above-mentioned related art is disclosed in Japanese unexamined patent application publication No. 2021-086813 (JP2021-086813A).

### SUMMARY

### Technical Problems

As disclosed in JP2021-086813A, one example of known terminal members has an L-shaped cross-section and includes a connection flat surface facing outside a case. This terminal member is formed for example of a flat plate-shaped metal member bent in an L shape. However, if the metal member is simply bent, a bent portion is formed with a rounded surface continuous to the connection flat surface. This configuration may not provide sufficient dimension of the connection flat surface.

### Means of Solving the Problems

To solve the above-mentioned failures, one aspect of the present disclosure provides a power storage device comprising: a case member made of metal and provided with an insertion hole; a terminal member inserted through the insertion hole; an electrode body accommodated in the case member and connected to the terminal member; and a resin member in contact with each of the case member and the terminal member to insulate between the case member and the terminal member, wherein the terminal member includes: an inner terminal part connected to the electrode body within the case member, and extending outside of the case member through the insertion hole; and an outer terminal part having a flat plate shape and located outside the case member, the outer terminal part including a connection flat surface that faces outside the case member and an internal surface that faces inside of the case member, the internal surface being continuous to an upper end of the inner terminal part, the terminal member is made of a flat plate-shaped metal member bent to have the inner terminal part and the outer terminal part, the outer terminal part includes: a main part extending from an area continuous to the upper end of the inner terminal part toward one side in a thickness direction of the inner terminal part, the main part forming a part over half of the connection flat surface; and a protruding portion protruding from the area continuous to the upper end of the inner terminal part toward another side in the thickness direction of the inner terminal part, the protruding portion forming a remaining part of the connection flat surface, the terminal member has a T-shaped cross-section at a portion including the area where the internal surface of the outer terminal part is continuous to the upper end of the inner terminal part.

According to the power storage device described above, the terminal member is made of a flat-plate metal member having been bent, and additionally the outer terminal part, forming the connection flat surface, includes the protruding portion on the side opposite the main part extending from the area continuous to the inner terminal part formed by bending. This configuration ensures a wider dimension of the connection flat surface as compared with a connection flat surface of a terminal member made of a flat-plate metal member which has a rounded surface formed as it is by simple bending and has no protruding portion.

According to the present disclosure, a power storage device can be achieved in which a terminal member has a sufficient dimension of a connection flat surface.

### BRIEF DESCRIPTION OF THE DRAWINGS

FIG. 1 is a perspective view of a battery in an embodiment;

FIG. 2 is a cross-sectional view of the battery in the embodiment, taken along a battery height direction and a battery width direction;

FIG. 3 is an enlarged partial top view of the battery in the embodiment, seen from above a lid, around an opening end of a case body and a peripheral edge portion of the lid;

FIG. 4 is an enlarged partial cross-sectional view of the battery in the embodiment, around the opening end of the case body and the peripheral edge portion of the lid, taken along the battery height direction and the battery width direction (A-A in FIG. 3);

FIG. 5 is an enlarged partial cross-sectional view of the battery in the embodiment, around the opening end of the case body and the peripheral edge portion of the lid, taken along the battery height direction and the battery width direction (B-B in FIG. 3);

FIG. 6 is a flowchart showing a method for producing the battery in the embodiment;

FIGS. 7A-7D are explanatory views showing a procedure of forging an outer terminal part in a terminal member forging step;

FIG. 8 is a schematic diagram showing a roughened surface of the lid in the embodiment;

FIG. 9 is a view of a lid assembly formed in a lid-assembly forming step;

FIG. 10 is an explanatory view showing that molten resin is injected into a mold in the lid-assembly forming step; and

FIG. 11 is an enlarged partial cross-sectional view of a battery in a comparative example, around an opening end of a case body and a peripheral portion of a lid, taken along a battery height direction and a battery width direction.

### DETAILED DESCRIPTION OF THE EXEMPLARY EMBODIMENTS

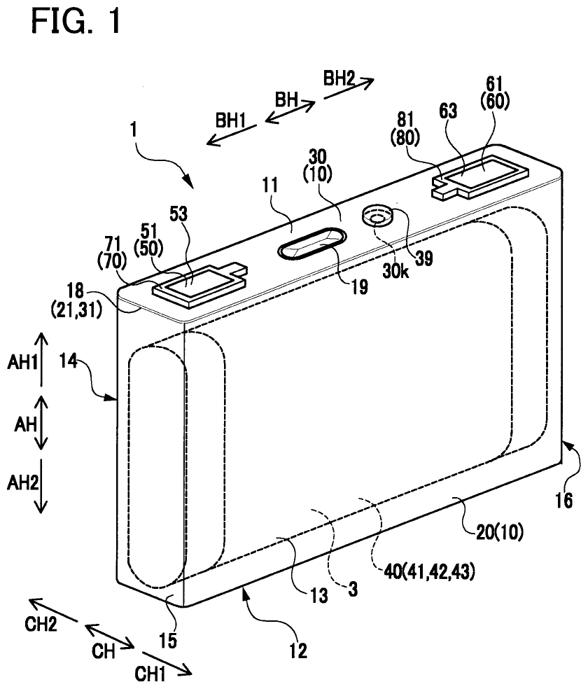

A detailed description of an embodiment will now be given referring to FIGS. 1 to 5. A battery 1 is one example of a power storage device of the present disclosure. In the following description, a battery height direction AH, a battery width direction BH, and a battery thickness direction CH of the battery 1 are defined as indicated by arrows in FIGS. 1 to 5. The battery 1 is a rectangular, i.e., rectangular parallelepiped-shaped, sealed lithium-ion secondary battery which will be installed in a vehicle, such as a hybrid car, a plug-in hybrid car, and an electric car.

### Configuration of Battery

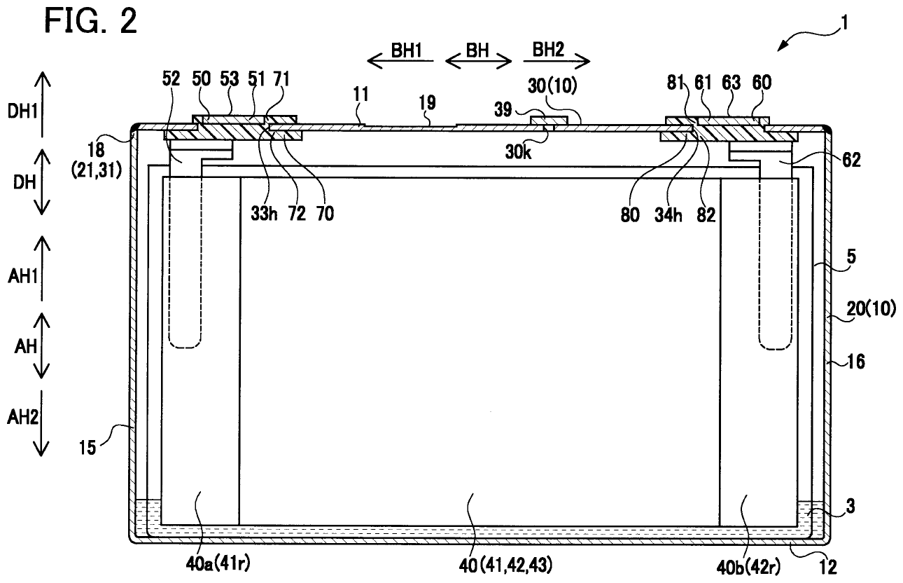

As shown in FIGS. 1 and 2, the battery 1 includes a case 10 having a rectangular parallelepiped shape, and an electrode body 40 accommodated in this case 10. The battery 1 further includes, in an upper part 11 located on the upper side AH1 in the battery height direction AH of the case 10, a positive terminal member 50 supported via a resin member 70 and a negative terminal member 60 supported via a resin member 80. Inside the case 10, the electrode body 40 is covered with a bag-shaped insulating holder 5 formed of an insulating film. The case 10 contains therein an electrolyte 3, a part of which is impregnated in the electrode body 40 and the rest of which is accumulated on a bottom part 12 located on the lower side AH2 in the battery height direction AH of the case 10.

The case 10 consists of a case body 20 and a lid 30. The case body 20 has a bottomed rectangular tube shape and includes an opening defined by a rectangular ring-shaped opening end 21 on the upper side AH1 in the battery height direction AH. Specifically, the case body 20 forms the bottom part 12 of the case 10, a large-width side part 13 of the case 10 on one side CH1 in the battery thickness direction CH, a large-width side part 14 of the case 10 on the other side CH2 in the battery thickness direction CH, a short-width side part 15 of the case 10 on one side BH1 in the battery width direction BH, and a short-width side part 16 of the case 10 on the other side BH2 in the battery width direction BH. Meanwhile, the lid 30 has a rectangular plate-like shape, forming the upper part 11 of the case 10. The lid 30 closes the opening defined by the opening end 21 of the case body 20 by laser-welding of a peripheral edge portion 31 of the lid 30 over the entire perimeter of the opening end 21 of the case body 20. By this laser-welding, a melt-solidification portion 18 is formed at the boundary between the lid 30 and the case body 20.

The lid 30 is further provided with a safety valve 19 which will break open when the internal pressure of the case 10 exceeds a valve opening pressure. The lid is also provided with a liquid inlet 30k which communicates between the inside and the outside of the case 10, and the liquid inlet 30k is hermetically sealed with a disc-shaped sealing member 39 made of aluminum.

Further, the lid 30 is formed with a rectangular insertion hole 33h penetrating in the lid thickness direction DH, near the end on the one side BH1 in the battery width direction BH, and a rectangular insertion hole 34h penetrating in the lid thickness direction DH, near the end on the other side BH2 in the battery width direction BH. The positive terminal member 50 made of aluminum is inserted through the insertion hole 33h and fixed to the lid 30 via the resin member 70 insulating between the terminal member 50 and the lid 30. The negative terminal member 60 made of copper is inserted through the insertion hole 34h and fixed to the lid 30 via the resin member 80 insulating between the terminal member 60 and the lid 30.

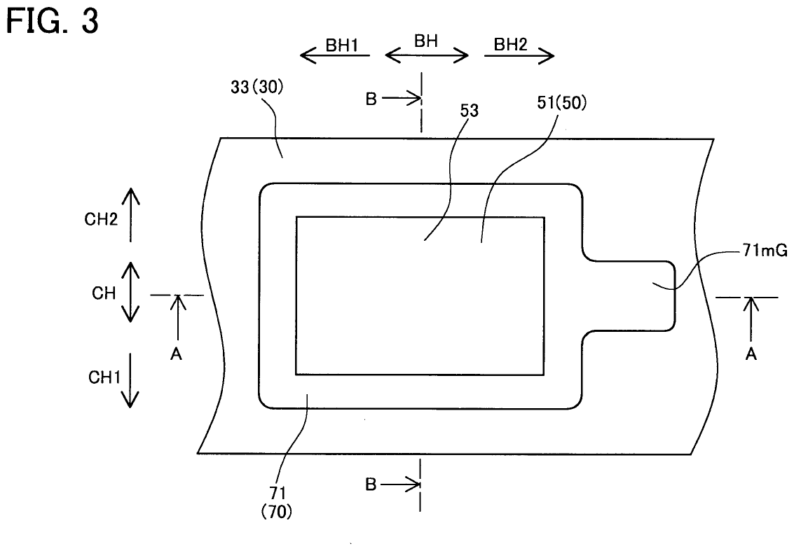

The terminal member 50 and 60 are each made of a metal plate, for example, an aluminum plate for the positive terminal member 50 and a copper plate for the negative 60 in the present embodiment, punched out in a predetermined shape and subjected to subsequent works, such as bending. Specifically, as shown in FIGS. 3 to 5, the positive terminal member 50 includes an outer terminal part 51 located outside the case 10, i.e., the lid 30, and an inner terminal part 52 located mainly inside the case 10 and continuous to the outer terminal part 51 through the insertion hole 33h.

The outer terminal part 51 has a rectangular flat plate shape and includes a connection flat surface 53 facing outward, i.e., toward the outside DH1 in the lid thickness direction DH of the lid 30. The connection flat surface 53 has no resin burrs and is entirely exposed, or uncoated. This entire connection flat surface 53 of the outer terminal part 51 can be used as the surface for connection with an external terminal such as a busbar. The outer terminal part 51 has an internal surface 54 facing inward, i.e., toward the inside DH2 in the lid thickness direction DH of the lid 30 and being continuous to the upper end of the inner terminal part 52. The internal surface 54 of the outer terminal part 51 is located higher on the upper side AH1 in the battery height direction AH than a surface 33 of the lid 30, which faces outward, i.e., toward the outside DH1 in the lid thickness direction DH.

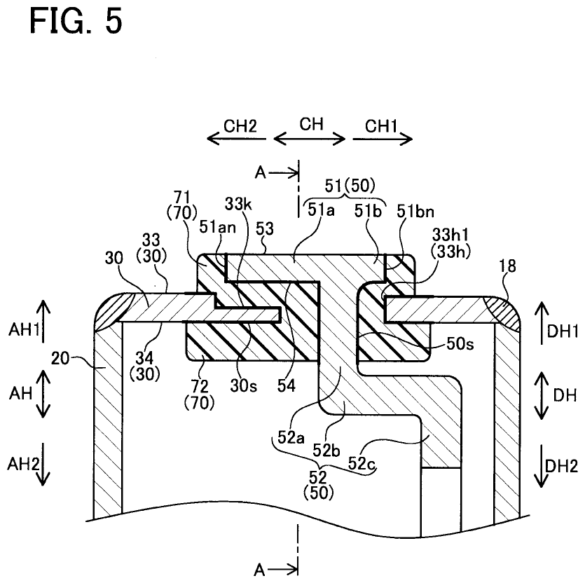

The inner terminal part 52 is bent at a plurality of locations. Concretely, the inner terminal part 52 includes, as shown in FIG. 5, a first inner portion 52a extending from the internal surface 54 of the outer terminal part 51 toward the lower side AH2 in the battery height direction AH, a second inner portion 52b bent at a lower end of the first inner portion 52a and extending toward the one side CH1 in the battery thickness direction CH, and a third inner portion 52c bent at the end of the second inner portion 52b on the one side CH1 in the battery thickness direction CH and extending toward the lower side AH2 in the battery height direction AH. The first inner portion 52a extends through the insertion hole 33h and is in contact with resin member 70. The third inner portion 52c is connected, at its end on the lower side AH2 in the battery height direction AH, to a positive current collecting part of the electrode body 40.

In the inner terminal part 52, the upper end of the first inner portion 52a is joined, or continuous, to a portion of the internal surface 54 of the outer terminal part 51, the portion being located slightly inside (i.e., to the other side CH2) relative to an end 51bn of the outer terminal part 51 located on the one side CH1 in the battery thickness direction CH. In other words, the terminal member 50 is bent in an area where the outer terminal part 51 and the inner terminal part 52 are joined to each other, which will be referred to as a joined area, and the outer terminal part 51 slightly protrudes from that joined area on the one side CH1 in the battery thickness direction CH. Thus, the terminal member 50 has a T-shaped cross-section at the joined area where the outer terminal part 51 is joined to the inner terminal part 52, formed by the outer terminal part 51 and the first inner portion 52a of the inner terminal part 52, as shown in FIG. 5. In the present embodiment, the outer terminal part 51 includes an outer main portion 51a located on the other side CH2 in the battery thickness direction CH relative to the joined area with the inner terminal part 52 and an outer protruding portion 51b located on the one side CH1 in the battery thickness direction CH relative to the joined area with the inner terminal part 52.

The outer protruding portion 51b slightly protrudes from the joined area continuous to the inner terminal part 52. The outer main portion 51a is a part more than half of the outer terminal part 51. Specifically, the surface of the outer main portion 51a is a part more than half of the connection flat surface 53 of the outer terminal part 51 and the surface of the outer protruding portion 51b is a remaining part of the connection flat surface 53.

The connection flat surface 53 of the outer terminal part 51 is parallel to the battery thickness direction CH in FIG. 5. The first inner portion 52a of the inner terminal part 52 extends in the battery height direction AH perpendicular to the battery thickness direction CH. Therefore, the thickness direction of the first inner portion 52a, which constitutes the area having a T-shaped cross-section, is the same as the battery thickness direction CH. It is thus can be said that the outer terminal part 51 consists of the outer main portion 51a extending from the joined area continuous to the upper end of the first inner portion 52a toward one side in the thickness direction of the first inner portion 52a and the outer protruding portion 51b extending from the joined area toward the other side in the thickness direction of the first inner portion 52a.

The lid 30 further includes a recessed portion 33k in the surface 33, which is recessed toward the inner side DH2 in the lid thickness direction DH, in a region extending from the insertion hole 33h on the other side CH2 in the battery thickness direction CH. The thickness of the lid 30 in a portion formed with the recessed portion 33k, i.e., the length of the lid 30 in the lid thickness direction DH, is about half the thickness of the lid 30 in another portion formed without the recessed portion 33k. The width of the recessed portion 33k in the battery thickness direction CH is from the edge of the insertion hole 33h to the location outside the outer main portion 51 an of the outer terminal part 51 on the other side CH2 in the battery thickness direction CH. The recessed portion 33k allows a part of the surface 33 of the lid 30 and a part of the internal surface 54 of the outer main portion 51a to overlap without contacting in the battery thickness direction CH.

Similarly, the negative 60 includes an outer terminal part 61 located outside the case 10, i.e., the lid 30, and an inner terminal part 62 mainly located inside the case 10 and continuous to the inner terminal part 62 through the insertion hole 34h. The shape of the negative 60 is the same as the positive terminal member 50 and thus the details thereof are omitted.

The electrode body 40 is a stacked electrode body having a flat rectangular parallelepiped shape, in which a plurality of positive electrode plates 41 and a plurality of negative electrode plates 42, each having a rectangular shape extending in the battery height direction AH and the battery width direction BH, are alternately stacked by interposing a plurality of separators 43 made of porous resin films, one between the electrode plates 41 and 42 in the battery thickness direction CH. Each of the positive electrode plates 41 includes a positive current collecting part 41r extending out on the one side BH1 in the battery width direction BH. The positive current collecting parts 41r overlap each other in the thickness direction, forming a positive tab 40a. This positive tab 40a is connected to the inner terminal part 52 of the positive terminal member 50 as mentioned above. Similarly, each of the negative electrode plates 42 includes a negative current collecting part 42r extending out on the other side BH2 in the battery width direction BH. The negative current collecting parts 42r overlap each other in the thickness direction, forming a negative tab 40b. This negative tab 40b is connected to the inner terminal part 62 of the negative terminal member 60 as mentioned above.

The resin member 70 is in contact with both the lid 30 and the positive terminal member 50 while insulating between the lid 30 and the positive terminal member 50. A part of the resin member 70 is firmly fixed, i.e., bonded, to the lid 30 and the terminal member 50. Similarly, the resin member 80 is in contact with both the lid 30 and the negative terminal member 60 while insulating between the lid 30 and the negative terminal member 60. A part of the resin member 80 is firmly fixed, i.e., bonded, to the lid 30 and the terminal member 60.

The resin member 70 is made of polyphenylene sulfide (PPS) and includes an outer insulating part 71 located outside the case 10, i.e., on the top of the lid 30, and an inner insulating part 72 located inside the case 10 and in the insertion hole 33h of the lid 30. The inner insulating part 72 is continuous to the outer insulating part 71 through the insertion hole 33h of the lid 30. The resin member 80 is also made of PPS and includes an outer insulating part 81 located on the top of the lid 30 and an inner insulating part 82 located inside the case 10 and in the insertion hole 34h of the lid 30. The inner insulating part 82 is continuous to the outer insulating part 81 through the insertion hole 34h of the lid 30.

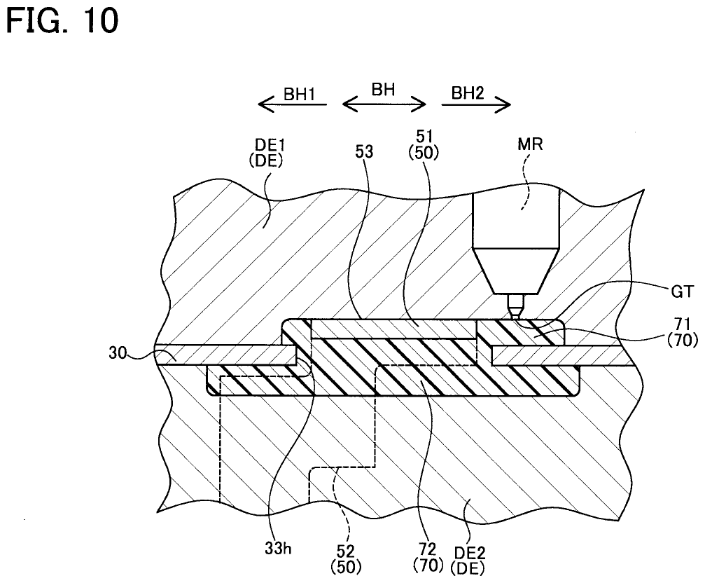

In the resin member 70, the outer insulating part 71 has a frame shape surrounding the outer terminal part 51, as shown in FIGS. 3 to 5. The outer insulating part 71 is continuous to the inner insulating part 72. This outer insulating part 71 has a shape, a part of which protrudes on the other side BH2 (i.e., rightward in FIG. 3) in the battery width direction BH, forming a protruding portion 71mG. The resin member 70 is made by insert-molding mentioned later. The protruding portion 71mG is a portion formed facing a gate member GT for injection of molten resin during the insert-molding (see FIG. 10). It is to be noted that the resin member 80 is identical in structure, except that the orientation is symmetrical with the resin member 70, as shown in FIGS. 1 and 2 and thus its details are omitted herein.

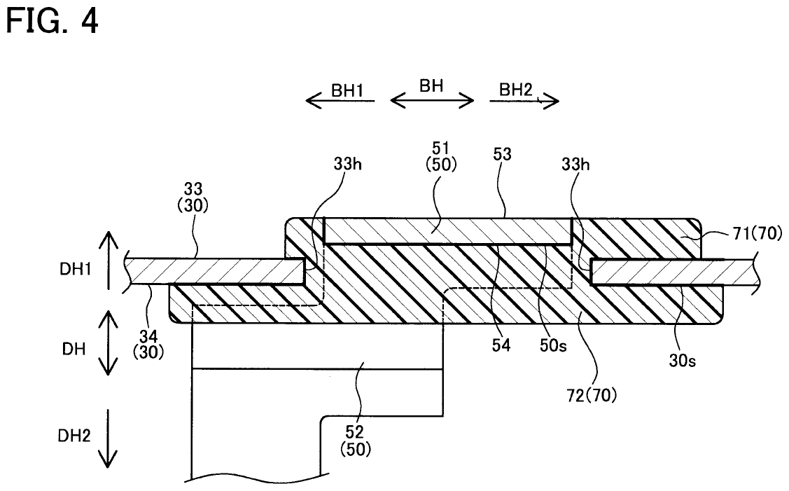

The surfaces (i.e., the surfaces 33 and 34) of the lid 30 include joined regions 30s (i.e., the surface areas indicated by thick lines in FIGS. 4 and 5) in contact with the resin member 70 and formed with minute (microscopic or nanoscopic) asperities by a surface-roughening treatment. Such surface-roughened joined regions 30s exhibits high tight-contact strength between the metal lid 30 and the resin member 70. Further, the resultant anchor effect enhances the bonding force between the lid 30 and the resin member 70. This surface-roughening treatment needs not be applied to the entire joined regions 30s contacting the resin member 70, but only to at least an area around the insertion hole 33h. This surface-roughened region allows the resin member 70 to be firmly fixed to the lid 30.

Similarly, the surfaces of the positive terminal member 50 include joined regions 50s (i.e., the surface areas indicated by thick lines in FIGS. 4 and 5) in contact with the resin member 70 and formed with minute asperities by the surface-roughening treatment. Such surface-roughened regions provided in all around the corresponding surface of the terminal member 50 allow the positive terminal member 50 to airtightly firmly fix to the resin member 70.

Furthermore, the surfaces of the lid 30 include joined regions in contact with the resin member 80 for the negative terminal member 60 and formed with minute asperities by the surface-roughening treatment, enhancing the bonding force between the lid 30 and the resin member 80. The surfaces of the negative terminal member 60 also include surface-roughened regions in contact with the resin member 80, which are formed with minute asperities. This surface-roughened regions of the negative terminal member 60 allow the negative terminal member 60 to airtightly firmly fix to the resin member 80.

### Production of Battery

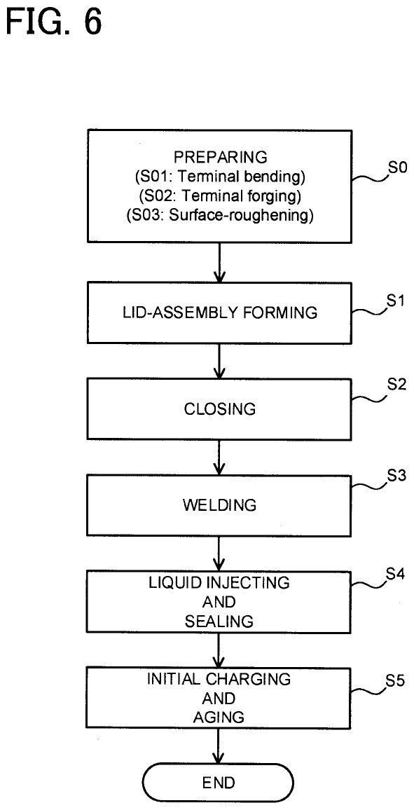

Next, the method for producing the battery 1 described above will be described below, referring to a flowchart in FIG. 6. In a preparing step S0, the lid 30 and the terminal members 50 and 60 are prepared first. The lid 30 is produced in advance for example by pressing an aluminum plate into a predetermined shape with the liquid inlet 30k, insertion holes 33h and 34h, and safety valve 19. The positive terminal member 50 is produced for example by pressing an aluminum plate and the negative terminal member 60 is produced for example by pressing a copper plate.

Specifically, a process for forming the outer terminal part 51 and the first inner portion 52a of the inner terminal part 52 in the positive terminal member 50 is described below. In a terminal bending step S01, firstly, a flat plate-shaped terminal member punched out from the aluminum plate is bent by coining at a bending angle of almost 90°, that is, into an L-shape. At this stage, the outer terminal part 51 is not formed yet with the outer protruding portion 51b.

In a terminal forging step S02, while the inner terminal part 52 is fixed, the end of the outer terminal part 51, that is, one end of the outer terminal part 51 on one side in the thickness direction of the inner terminal part 52 (corresponding to the other side CH2 in the battery thickness direction CH shown in FIG. 5) is struck toward the other side in the thickness direction of the inner terminal part 52 (corresponding to the one side CH1 in the battery thickness direction CH shown in FIG. 5) to form the outer protruding portion 51b in the outer terminal part 51.

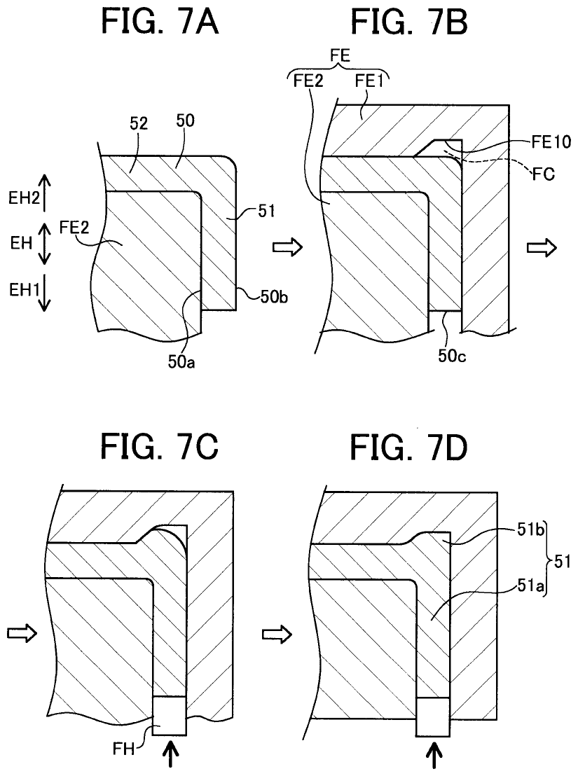

This terminal forging step S02 is performed in for example the following process as shown in FIGS. 7A-7D, using a die FE including an upper die FE1 and a lower die FE2. Firstly, as shown in FIG. 7A, the terminal member 50 formed in an L shape is set on the lower die FE2 so that an inner surface 50a of the terminal member 50 contacts the lower die FE2. Secondly, as shown in FIG. 7B, the upper die FE1 is moved into contact with an outer surface 50b of the terminal member 50. In this state, the end of the outer terminal part 51, that is, a one-end face 50c of the outer terminal part 51 located on one side EH1 in a thickness direction EH of the inner terminal part 52, is exposed from (i.e., uncovered by) the die FE constituted of the upper die FE1 and the lower die FE2. The upper die FE1 and the lower die FE2 are placed under pressure against the inner terminal part 52 of the terminal member 50 to secure the inner terminal part 52 in the die FE.

The upper die FE1 is provided with a recess FE10 having a groove shape extending in a direction perpendicular to the paper sheet in FIGS. 7A-7D and corresponding to the shape of the outer protruding portion 51b, at a position corresponding to the corner of the outer terminal part 51, that is, an end portion of the outer terminal part 51 on the other side EH2 in the thickness direction EH of the inner terminal part 52. Accordingly, at the stage where the upper die FE1 is placed in contact with the terminal member 50, the die FE has a space FC defined by the recess FE10 of the upper die FE1 and the outer surface 50b of the terminal member 50.

Then, as shown in FIG. 7C, the one-end face 50c of the outer terminal part 51 is struck with a hammer FH toward the other side EH2 in the thickness direction EH of the inner terminal part 52, thereby pushing the outer terminal part 51 toward the other side EH2 in the thickness direction EH of the inner terminal part 52 to deform the outer terminal part 51 so that to fill up the space FC. When the one-end face 50c is repeatedly struck with the hammer FH, the outer terminal part 51 is deformed to fill up the space FC, thus forming the outer protruding portion 51b as shown in FIG. 7D. By deforming the outer terminal part 51, it is possible to adjust the length of outer terminal part 51 in the thickness direction EH.

In a surface roughening step S03, subsequently, the surface-roughening treatment is applied to predetermined regions of the terminal member 50 having undergone the forging step, corresponding to the joined regions 50s that contact the resin member 70 formed by insert-molding mentioned later. Specifically, each region targeted for the surface-roughening treatment is subjected to the following process. Firstly, a first region in the target region for the surface-roughening treatment is irradiated with a laser beam and thus melted. As the terminal member 50 made of metal melts, metal particles are generated from metal vapor or plasma released into the atmosphere, and those metal particles are deposited again on and around the first region.

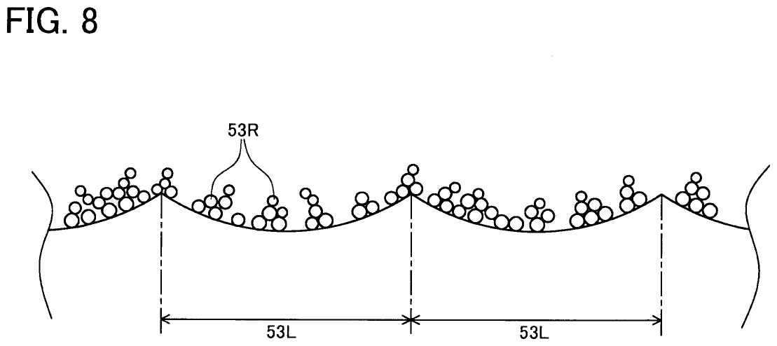

Successively, a second region adjacent to the first region is irradiated with the laser beam and thus melted, causing metal particles to deposit on the second region as in the first region. By irradiation of the laser beam over the entire target region for the surface-roughening treatment, a plurality of pits 53L is formed by the laser beam and a plurality of projections 53R is formed by deposition of metal particles on the target region as shown in FIG. 8. Thus, the target region is formed, on its entire surface, with minute asperities on the order of nanometers (nm). The same surface-roughening treatment is also applied to predetermined regions of the negative terminal member 60. Similarly, this surface-roughening treatment is also applied to a predetermined region of the lid 30, which corresponds to the joined region 30s that contacts the resin member 70 formed by insert-molding described later.

This surface roughening step S03 needs only to be performed before a lid-assembly forming step S1 mentioned later. For example, the surface roughening step S03 may be performed before the terminal bending step S01 or may be executed after terminal bending step S01 but before terminal forging step S02.

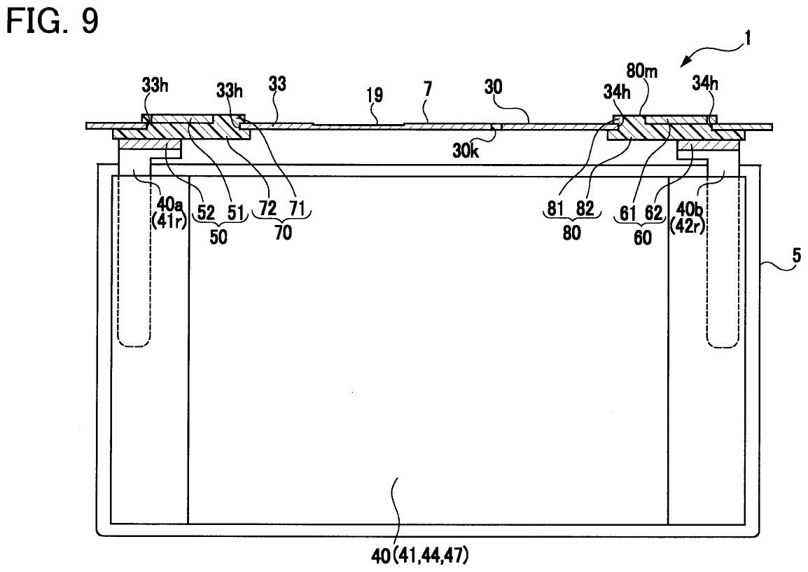

In the lid-assembly forming step S1, a lid assembly 7 shown in FIG. 9 is formed. This lid assembly 7 is an integral unit including several parts of the battery 1, i.e., the lid 30 having been subjected to the surface-roughening treatment, the terminal members 50 and 60 having been subjected to the surface-roughening treatment, the resin members 70 and 80, and the electrode body 40 enclosed by the insulating holder 5. In this lid-assembly forming step S1, the lid 30 and the terminal members 50 and 60 are prepared, and the resin members 70 and 80 are made by insert-molding, so that the terminal members 50 and 60 are integrated to the lid 30 via the resin members 70 and 80 respectively.

Concretely, in the lid-assembly forming step S1 using a mold DE having an upper mold DE1 and a lower mold DE2, the lid 30 is set at a predetermined position in the lower mold DE2 as shown in FIG. 10. Subsequently, the terminal members 50 and 60 are respectively inserted in the insertion holes 33h and 34h of the lid 30 set in the lower mold DE2. The upper mold DE1 is then moved down onto the lower mold DE2 to close the mold DE. Further, molten resin MR is injected into the mold DE and then cooled, forming the resin members 70 and 80. After that, the upper mold DE1 is moved upward, and a composite molded product in which the lid 30 is integrated with the terminal members 50 and 60 via the resin members 70 and 80 respectively is taken out of the lower mold DE2.

In the present embodiment, since the resin member 70 is formed by insert-molding, this resin member 70 includes a region which connects to, or faces, the gate member GT through which the molten resin MR is injected into the mold DE. This region facing the gate member GT forms the protruding portion 71mG of the outer insulating part 71 of the resin member 70.

Next, the electrode body 40 is prepared, in which the positive electrode plates 41, negative electrode plates 42, and separators 43 are stacked. To the positive tab 40a and the negative tab 40b of the electrode body 40, the inner terminal part 52 of the terminal member 50 and the inner terminal part 62 of the terminal member 60 of the composite molded product are respectively connected by welding. Then, this electrode body 40 is enclosed in the pouched insulating holder 5. Thus, the lid assembly 7 consisting of the lid 30, terminal members 50 and 60, resin members 70 and 80, electrode body 40, and insulating holder 5 is formed.

In a closing step S2, the case body 20 is prepared, the electrode body 40 covered by the insulating holder 5 of the lid assembly 7 formed in the lid-assembly forming step S1 is inserted into the case body 20, and the lid 30 is placed with its peripheral edge portion 31 closing the opening end 21 of the case body 20.

In a welding step S3, a laser beam is applied to the opening end 21 of the case body 20 and the peripheral edge portion 31 of the lid 30, from the outside DH1 in the lid thickness direction DH of the lid 30, i.e., from the upper side AH1 in the battery height direction AH, forming a melt-solidification portion 18 over the entire perimeter of the opening end 21 and the peripheral edge portion 31. Thus, the case 10 is completed.

In a liquid injecting and sealing step S4, the electrolyte 3 is injected into the case 10 through the liquid inlet 30k to impregnate the electrode body 40 with the electrolyte 3. Thereafter, the liquid inlet 30k is covered with the closing member 39 from the outside, and the closing member 39 is welded, over its entire circumference, to the lid 30, thereby hermetically sealing between the closing member 39 and lid 30.

In an initial charging and aging step S5, a charging device (not shown) is connected to the battery 1 and initially charges the battery 1. Then, the initially charged battery 1 is allowed to stand for a predetermined time to age. Thus, the battery 1 is completed.

According to the battery 1 in the present embodiment, the terminal member 50 is formed of a flat plate-shaped metal member bent into a predetermined shape including the connection flat surface 53. The outer terminal part 51 having this connection flat surface 53 consists of the outer main portion 51a extending by bending from the area joined to the inner terminal part 52 and further the outer protruding portion 51b extending from that joined area to the opposite side. These outer main portion 51a and outer protruding portion 51b form the connection flat surface 53. In other words, the outer terminal part 51 and the inner terminal part 52 have a T-shaped cross-section at the joined area where these parts 51 and 52 are joined. Thus, the terminal member 50 in the present embodiment can have the connection flat surface 53 wider than a connection flat surface of a terminal member which has a rounded face formed as it is by bending and has no outer protruding portion 51b.

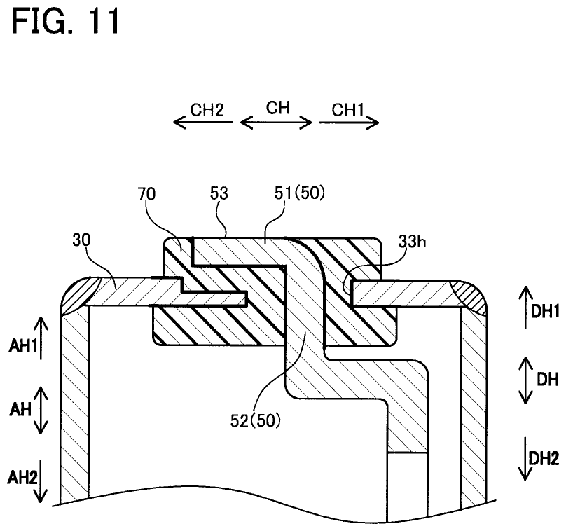

Specifically, as shown in a comparative example in FIG. 11, when the joined area of those outer terminal part 51 and inner terminal part 52 has an L-shaped cross-section with a rounded surface left as it is after bending, the length of the connection flat surface 53 in the battery thickness direction CH may be too short to ensure a sufficient dimension of the connection flat surface 53. In contrast, since the battery 1 in the present embodiment includes the outer protruding portion 51b, the length of the connection flat surface 53 in the battery thickness direction CH is thus enough long to ensure a sufficient dimension of the connection flat surface 53.

It is also conceivable that the first inner portion 52a of the inner terminal part 52 is placed more outward to the one side CH1 in the battery thickness direction CH, as compared with the battery 1 in the present embodiment, and the insertion hole 33h is widened toward the one side CH1 in the battery thickness direction CH in order to ensure a sufficient dimension of the connection flat surface 53. However, such a configuration results in a shorter distance from the opening edge of the insertion hole 33h to the outer edge of the lid 30 on the one side CH1 in the battery thickness direction CH, which causes the following problems. Specifically, because of the insertion hole 33h widened toward the one side CH1 in the battery thickness direction CH, the dimension of the outer insulating part 71 of the resin member 70 needs to be increased on the one side CH1 in the battery thickness direction CH in order to ensure the dimension of the joined region 30s for sealing between the resin member 70 and the lid 30. In this case, the distance between the resin member 70 and the welded site (which will become the melt-solidification part 18) becomes shorter, which may cause the outer insulating part 71 to be scorched or burnt when the lid 30 is welded to the case body 20. On the other hand, if the outer insulating part 71 of the resin member 70 is not increased in dimension as above, the joined region 30s for sealing between the resin member 70 and the lid 30 remains narrow, so that joining between the resin member 70 and the lid 30 is apt to be broken, resulting in leakage of internal gas.

In the battery 1 in the present embodiment, the terminal member 50 has a T shape, so that the connection flat surface 53 can have a sufficient dimension and also the insertion hole 33h of the lid 30 can be located to the other side CH2 in the battery thickness direction CH as compared to the comparative example. In the present embodiment, for example, the outer protruding portion 51b of the outer terminal part 51 has the end 51bn on the one side CH1 in the battery thickness direction CH, which is located at almost the same position in the battery thickness direction CH (i.e., on the same plane perpendicular to the battery thickness direction CH) as the side surface 33h1 of the insertion hole 33h on the one side CH1 in the battery thickness direction CH as shown in FIG. 5. This configuration ensures a sufficient dimension of the joined region 30s that seals between the resin member 70 and the lid 30, so that joining between the resin member 70 and the lid 30 is less likely to be broken. In addition, in the battery 1 in the present embodiment, the outer insulating part 71 of the resin member 70 needs not be widened toward the one side CH1 in the battery thickness direction CH, so that the outer insulating part 71 is unlikely to be scorched or burnt during welding.

The foregoing embodiments are mere examples and give no limitation to the present disclosure. The present disclosure may be embodied in other specific forms without departing from the essential characteristics thereof. For example, the electrode body accommodated in the case 10 is shown as the stacked electrode body in the foregoing embodiment, but it may be a flat wound electrode body. As another alternative, a plurality of electrode bodies may be accommodated together in a single case.

In the foregoing embodiment, the present disclosure is applied to the lithium ion battery. However, the present disclosure is applicable to any general power storage devices, such as a nickel-metal hydride battery or a nickel-cadmium battery.

In the foregoing embodiment, the surface-roughening treatment is performed by irradiation of a laser beam to form metal deposits (anchors) on the metal surface. As an alternative, any general surface-roughening treatments may be adopted. For example, a surface-roughening treatment using an acid-based etching agent may be adopted to form pores in the metal surface.

In the foregoing embodiment, as shown in FIG. 5, the end 51bn of the outer protruding portion 51b of the outer terminal part 51 on the one side CH1 in the battery thickness direction CH is located at almost the same position in the battery thickness direction CH as the side surface 33h1 of the insertion hole 33h on the one side CH1 in the battery thickness direction CH. As an alternative, the lid 30 may be configured with a longer length between the opening edge of the insertion hole 33h and the outer edge of the lid 30 on the one side CH1 in the battery thickness direction CH so that the side surface 33h1 of the insertion hole 33h on the one side CH1 in the battery thickness direction CH is located more inward, toward the other side CH2, in the battery thickness direction CH as compared with the above embodiment. This configuration increases the contact area of the lid 30 with the resin member 70 and increases the surface area of the surface-roughened joined region 30s of the lid 30, so that joining between the resin member 70 and the lid 30 is less likely to be broken.

### REFERENCE SIGNS LIST

1 Battery (Power storage device)
10 Case
20 Case body
30 Lid
30s Joined region (Seal region)
33h Insertion hole
50 Terminal member
51 Outer terminal part
51a Outer main portion (Main portion)
51b Outer protruding portion (Protruding portion)
52 Inner terminal part
53 Connection flat surface
70 Resin member

What is claimed is:

1. A power storage device comprising:
a case member made of metal and provided with an insertion hole;
a terminal member inserted through the insertion hole;
an electrode body accommodated in the case member and connected to the terminal member; and
a resin member in contact with each of the case member and the terminal member to insulate between the case member and the terminal member,
wherein the terminal member includes:
an inner terminal part connected to the electrode body within the case member, and extending outside of the case member through the insertion hole; and
an outer terminal part having a flat plate shape and located outside the case member, the outer terminal part including a connection flat surface that faces outside the case member and an internal surface that faces inside of the case member, the internal surface being continuous to an upper end of the inner terminal part,
the terminal member is made of a flat plate-shaped metal member bent to have the inner terminal part and the outer terminal part,
the outer terminal part includes:
a main part extending from an area continuous to the upper end of the inner terminal part toward one side in a thickness direction of the inner terminal part, the main part forming a part over half of the connection flat surface; and
a protruding portion protruding from the area continuous to the upper end of the inner terminal part toward another side in the thickness direction of the inner terminal part, the protruding portion forming a remaining part of the connection flat surface,
the terminal member has a T-shaped cross-section at a portion including the area where the internal surface of the outer terminal part is continuous to the upper end of the inner terminal part.

2. The power storage device according to claim 1, wherein the terminal member has the T-shaped cross-section formed by the inner terminal part and the outer terminal part made of the flat plate-shaped metal member bent in an L-shape, the outer terminal part including an end on the one side in the thickness direction of the inner terminal part, which have been hammered toward the other side in the thickness direction of the inner terminal part while the inner terminal part is fixed.

3. The power storage device according to claim 1, wherein the case member has a surface including a seal region that is at least a part of a region contacting the resin member and has been surface-roughened.

4. The power storage device according to claim 2, wherein the case member has a surface including a seal region that is at least a part of a region contacting the resin member and has been surface-roughened.

5. The power storage device according to claim 3, wherein the surface of the case member includes an outside-facing surface that faces outside the case member and includes the seal region in the region contacting the resin member and extending from the insertion hole on another side in the thickness direction of the inner terminal part.

6. The power storage device according to claim 4, wherein the surface of the case member includes an outside-facing surface that faces outside the case member and includes the seal region in the region contacting the resin member and extending from the insertion hole on another side in the thickness direction of the inner terminal part.
